(19) United States
(12) Patent Application Publication
(10) Pub. No.: US 2025/0132087 A1
(43) Pub. Date: Apr. 24, 2025

(54) MAGNETIC COMPONENT

(71) Applicant: Delta Electronics (Thailand) Public Co., Ltd., Samutprakarn (TH)

(72) Inventors: Hugues NJIENDE, Soest (DE); Shangeeth Kumar SHANMUGHAM, Soest (DE); Eugen SCHWAN, Soest (DE); Sergey TIKHONOV, Soest (DE)

(21) Appl. No.: 18/898,722

(22) Filed: Sep. 27, 2024

(30) Foreign Application Priority Data
Oct. 19, 2023 (EP) 23204551.8

(51) Int. Cl. H01F 27/32; H01F 27/24

(52) U.S. Cl. CPC H01F 27/325; H01F 27/24

(57) ABSTRACT

The application concerns a magnetic component comprising a multi-part bobbin and at least one winding unit, the multi-part bobbin further comprising a plurality of holding parts configured to hold the at least one winding unit, wherein the at least one winding unit is pre-wound and comprises one or more coil winding turns, wherein at least one of the holding parts comprises a cylindrical portion inserted into, along a longitudinal axis of the winding unit, at least one winding unit so as to be surrounded thereby, and wherein said cylindrical portion is in contact and attached to a separate holding part via a form-fit connection.

### CROSS-REFERENCE TO RELATED APPLICATIONS

This application claims priority to European Patent Application No. 23204551.8, filed on Oct. 19, 2023, which is hereby incorporated by reference in its entirety.

### TECHNICAL FIELD

The application concerns a magnetic component comprising a multi-part bobbin and at least one winding unit.

### BACKGROUND

Conventionally, magnetic components comprising multi-part bobbins and winding units, for example in the use of transformers, are known. Examples of multi-part bobbin configurations are known from JP 2013-179259, U.S. Pat. No. 6,927,650 B2, and JP 6479235 B1.

Generally, multi-part bobbins are used in applications in which a winding process of the coil is not possible for single-part bobbins, for example in a case of edge-wise winding due to possible damage to the bobbin and/or the coil. Therefore, multi-part bobbins are used in such applications, wherein the coil is pre-wound on a separate device before being attached to the bobbin.

However, conventional multi-part bobbins have the disadvantage in that they are cumbersome and complicated to assemble. In some examples, additional gluing of the parts thereof is necessary.

### SUMMARY

At least one object of the present application is to overcome these deficiencies. In particular, it is an object of the present application to provide a magnetic component comprising a multi-part bobbin and at least one winding unit which is easy to assemble and requires few manufacturing steps thereby. Further objects and advantages of the present application will be laid out in the following.

The solution of these objects is achieved by the subject matter of the independent claim. The dependent claims concern advantageous embodiments of the present application.

In particular, the solution of these objects is provided by the subject matter of claim 1. A magnetic component according thereto comprises a multi-part bobbin and at least one winding unit. Further, the multi-part bobbin thereof comprises a plurality of holding parts configured to hold the at least one winding unit, wherein the at least one winding unit is pre-wound and comprises one or more coil winding turns. In some embodiments, the at least one winding unit is edgewise pre-wound, i.e. comprises one or more edgewise coil winding turns. Therein, at least one of the holding parts comprises a cylindrical portion inserted into, along a longitudinal axis of the winding unit, at least one winding unit so as to be surrounded thereby. Further, said cylindrical portion is in contact and attached to a separate holding part via a form-fit connection.

Thereby, a magnetic component which can be easily assembled is provided.

In the foregoing and in the following, the term “winding unit” refers to a coil winding. To differentiate between an individual winding, i.e. a “turn of a winding”, the term “winding unit” is chosen. Further, a winding unit comprises the aforementioned coil winding turns and is characterized by comprising two ends of said coil winding turns in some embodiments. In other words, a single coil comprising two coil (wire) ends equates to a winding unit. An end of the coil winding is, irrespective of its further connection, characterized in that it extends radially from the other wound portions of the coil winding in some embodiments.

In the foregoing and in the following, the term “cylindrical”, especially with respect to the “cylindrical portion” refers to a cylindrical, i.e. longitudinally extended and hollow, shape. For example, the cylindrical portion is circular cylindrical (i.e. circular cross-section), oval cylindrical, square or rectangular cylindrical, especially with rounded edges, or angular, especially triangular, cylindrical in some embodiments. In some embodiments, the cross-sectional shape of the cylindrical portion corresponds to a cross-sectional shape of the at least one winding unit.

In some embodiments, the longitudinal axis of the winding unit is defined as being parallel to the winding axis of the one or more coil winding turns of the winding unit.

In some embodiments, the plurality of holding parts are separate, individual components or parts of the multi-part bobbin. In other words, the holding parts are preferably not integral or monolithic with one another.

Although the foregoing and following particularly describes a magnetic component comprising a multi-part bobbin and at least one winding unit, it is to be understood that the magnetic component may comprise a plurality of multi-part bobbins in some embodiments. These are attached to one another via a common base plate or a common magnetic core in some embodiments, for example, as will be shown in the embodiments below.

In some embodiments, the form-fit connection is detachable, particularly destruction-free detachable. This allows for easy connection of the holding parts, as well as de-connection in case for example a mistake is made during manufacturing (for instance, holding parts are connected without first being inserted into winding unit).

In some embodiments, the form-fit connection is a snap-fit connection. Alternatively thereto, or in addition with reference to multiple form-fit connections, the form-fit connection is a twist-and-lock connection.

In some embodiments, in the case of snap-fit connection, one component (cylindrical portion or plate-shaped holding part) comprises a hook or cantilever and the respective other component comprises the accommodating snap-in area.

In some embodiments, in the case of twist-and-lock connection, one component comprises a hook or cantilever, whereas the respective other component comprises an annular groove or annular undercut, wherein the groove or undercut comprises, along its annular extension, one or more recesses into which the hook or cantilever is insertable. By inserting the hook or cantilever into the recess, and twisting the components (turning around longitudinal axis), the hook or cantilever is disposed behind a (recess-free) portion of the annular groove/undercut, such that its movement along the longitudinal axis is blocked.

In some embodiments, at least two separate holding parts of the holding parts respectively comprise said cylindrical portion. Therein, the two cylindrical portions of the two separate holding parts are inserted into a single winding unit of the at least one winding unit. Further, said two cylindrical portions within said single winding unit contact and are attached to one another via the form-fit connection. In other words, at least one winding unit surrounds two cylindrical portions of two separate holding parts, i.e. one cylindrical portion of one holding part and one (other) cylindrical part of another holding part.

In some embodiments, the form-fit connection is disposed within the respective winding unit. In other words, the respective winding unit surrounds the form-fit connection in some embodiments.

Advantageously, respective first end faces of said two cylindrical portions contact one another within said one winding unit. In some embodiments, the individual (for example hook/cantilever or snap-in area) components of the form-fit connection are respectively disposed at the first end faces of said two cylindrical portions.

In some embodiments, the first end face of a first cylindrical portion out of said two cylindrical portions is tapered so as to be insertable into a second cylindrical portion out of said two cylindrical portions.

In some embodiments, the at least two separate holding parts comprising said cylindrical portion each further comprise a lid flange portion. Further, each lid flange portion is in contact with an end face, along the longitudinal axis, of the at least one winding unit. In some embodiments, the lid flange portions prevent or limit movement of the winding unit along the longitudinal axis. Thereby, longevity and electric insulation of the magnetic component is improved.

In some advantageous embodiments, said two cylindrical portions contact and attach to one another at a center portion, along the longitudinal axis, of the respective winding unit. In some embodiments, the center portion is defined as the center or middle of the winding unit within a margin of error. For example, the center portion is defined by dividing (in thought) the winding unit, along its longitudinal axis, into eighths, wherein the center portion is within the two middle eighths. In some embodiments, the center portion is defined by the geometric middle within a range of ±15%, or ±10%, of the total length of the winding unit along its longitudinal axis. In some embodiments, the total length of the winding unit is determined by the wound portions thereof, especially only the wound portions thereof, i.e. not including the aforementioned ends of the winding, in the case these also extend along the longitudinal axis.

Alternatively or in addition, with respect to different cylindrical portions for example, out of said two cylindrical portions, one is longer along the longitudinal axis such that said two cylindrical portions contact and attach to one another at an end portion, along the longitudinal axis, of the respective winding unit. In some embodiments, a point of contact at the end portion of the two cylindrical portions is defined, with respect to the winding unit, as within a length range of 25% or less, or 15% or less, or 10% or less or 5% or less, from an end of the winding unit, particularly the wound portions thereof. For example, in the case of 25%, the cylindrical portion of one holding part would be for example 75 mm and the cylindrical portion of the other holding part within the same winding unit would be 25 mm long along the longitudinal axis of the winding unit.

In some embodiments, three holding parts of the holding parts of the multi-part bobbin respectively comprise said cylindrical portions. Therein, one of the three holding parts comprises two of said cylindrical portions, and is denoted as “two-sided holding part”, wherein each of these cylindrical portions is inserted respectively into one winding unit and connects respectively with one cylindrical portion of one of the other two holding parts out of said three holding parts. For example, one holding part comprises a cylinder portion inserted into a winding unit. Further, the two-sided holding part also comprises a cylinder portion inserted into the same winding unit. Further yet, another holding part comprises a cylinder portion inserted into a different (second) winding unit. The two-sided holding part comprises a cylinder portion also inserted into the different (second) winding unit. Thereby, a multi-part bobbin is capable of carrying at least two separate winding units. In some embodiments, any one or more of the other two holding parts (those apart from the aforementioned two-sided holding part) can be replaced by another two-sided holding part, thus allowing for many winding units being carried thereby.

In some embodiments, the two of said cylindrical portions of said two-sided holding part extend in opposite directions along the longitudinal axis. Thereby, the multiple winding units are stacked along the longitudinal axis in some embodiments.

In some embodiments, each of said two cylindrical portions of said two-sided holding part can respectively be inserted into more than one winding unit. For instance, each of the two cylindrical portions of said two-sided holding part can be inserted into two winding units in some embodiments, respectively.

In some embodiments, the aforementioned two-sided holding part comprises a flange portion which connects the two cylindrical portions. Furthermore, the flange portion separates, along the longitudinal axis, the two (or more) winding units into which the cylindrical portions of the two-sided holding part are inserted. Thereby, the flange portion provides a fixed insulation distance between the two winding units on either side thereof, especially those (in the case of multiple winding units on either side) directly on either side thereof.

In some embodiments of the two-sided holding part with the flange portion, in combination with the other holding parts comprising a lid flange portion in contact with an end face of the at least one winding unit, each winding unit is sandwiched, along the longitudinal axis, between the flange portion of the two-sided holding part and the lid flange portion of one of the two other holding parts. Alternatively, in the case of multiple two-sided holding parts, at least one winding unit may be sandwiched between the flange portions of two two-sided holding parts.

In another embodiment, at least one of the holding parts comprises a plate shape and is denoted as “a plate-shaped holding part”. The plate-shaped holding part in some embodiments does not comprise a cylindrical portion inserted into the winding unit. Therein, the cylindrical portion of one other holding part is inserted into the winding unit and attached to the plate-shaped holding part. The plate-shaped holding part is further in contact with an end face of the winding unit. In some embodiments, along the longitudinal axis, an end face of the plate-shaped holding part is in contact with an end face of the winding unit. In some embodiments, the aforementioned winding unit is sandwiched between the plate-shaped holding part and a lid flange of the other holding part or a flange portion of a two-sided holding part.

In some embodiments, in an embodiment comprising at least two winding units, at least two of the holding parts respectively comprise the cylindrical portion. Further therein, the two cylindrical portions are inserted respectively into separate winding units and attached on either end face of the plate-shaped holding part.

In some embodiments, the cylindrical portion of at least one holding part comprises at least one slot configured to respectively accommodate at least one ferrite pill and a magnetic core. In some embodiments, the ferrite pill is a (thick-) disc-shaped component comprising ferrite material, for instance as a pressed powder. In some embodiments, each slot is configured to accommodate at least one ferrite pill. In other words, the number of slots and the number of ferrite pills are equal.

In some embodiments, a cross-sectional shape of the one or more ferrite pills corresponds to the aforementioned cross-sectional shape of the cylindrical portion (circular, oval, angular, rounded edges, etc.). This has the advantage of a tight fit of the ferrite pill(s) within the cylindrical portion.

In some embodiments, the cylindrical portion is hollow and houses at least a portion of a magnetic core. For instance, the magnetic core is rod-shaped and is inserted into the cylindrical portion. In other examples, the magnetic core comprising winding legs and return legs, connected via a base plate, wherein the winding legs thereof are respectively inserted into the cylindrical portion.

In some embodiments, the cylindrical portion has a circular or oval cross-section.

In some embodiments, the cylindrical portion of at least one holding part is respectively inserted into at least two winding units.

In some embodiments, the holding part comprises two halves, for example half-cylinders, which are connected to one another, especially integrally or monolithically, via a hinge portion. Thereby, the aforementioned magnetic core and/or ferrite pill(s) can be easily inserted into the cylindrical portion. Therein, the cylindrical portion comprises two halves and the lid flange portion comprises two halves.

The present invention also concerns a method of manufacturing a magnetic component of any one of the foregoing embodiments. Therein, the method comprises at least the steps of inserting multiple holding parts longitudinally into a pre-wound winding unit and attaching them to one another via the form-fit connection. In some embodiments, in an additional step, the magnetic core is inserted into the cylindrical portion before or after insertion thereof into the winding unit.

### BRIEF DESCRIPTION OF THE DRAWINGS

Further details, advantages, and features of the embodiments of the present application are described in detail with reference to the figures. Therein:

FIG. 1 shows a schematic explosion view of a magnetic component according to a first embodiment of the present application.

FIG. 2 shows a schematic assembled cross sectional view of the magnetic component according to the first embodiment of the present application.

FIG. 3 shows a schematic explosion view of the magnetic component according to the first embodiment of the present application.

FIG. 4 shows a schematic assembled view of the magnetic component according to the first embodiment of the present application.

FIG. 5 shows a schematic explosion view of a magnetic component according to a second embodiment of the present application.

FIG. 6 shows a schematic assembled cross sectional view of a magnetic component according to the second embodiment of the present application.

FIG. 7 shows a schematic explosion view of a magnetic component according to a third embodiment of the present application.

FIG. 8 shows a schematic assembled cross sectional view of the magnetic component according to the third embodiment of the present application.

FIG. 9 shows a schematic explosion view of the magnetic component according to the third embodiment of the present application.

FIG. 10 shows a schematic assembled view of the magnetic component according to the third embodiment of the present application.

FIG. 11 shows a schematic explosion view of a magnetic component according to a fourth embodiment of the present application.

FIG. 12 shows a schematic assembled cross sectional view of the magnetic component according to the fourth embodiment of the present application.

FIG. 13 shows a schematic explosion view of the magnetic component according to the fourth embodiment of the present application.

FIG. 14 shows a schematic assembled view of the magnetic component according to the fourth embodiment of the present application.

FIG. 15 shows a schematic explosion view of aspects of a magnetic component according to a fifth embodiment of the present application.

FIG. 16 shows another schematic explosion view of aspects of the magnetic component according to the fifth embodiment of the present application.

FIG. 17 shows a schematic exploded view of an aspect of a magnetic component according to a sixth embodiment of the present application.

### DESCRIPTION OF EMBODIMENTS

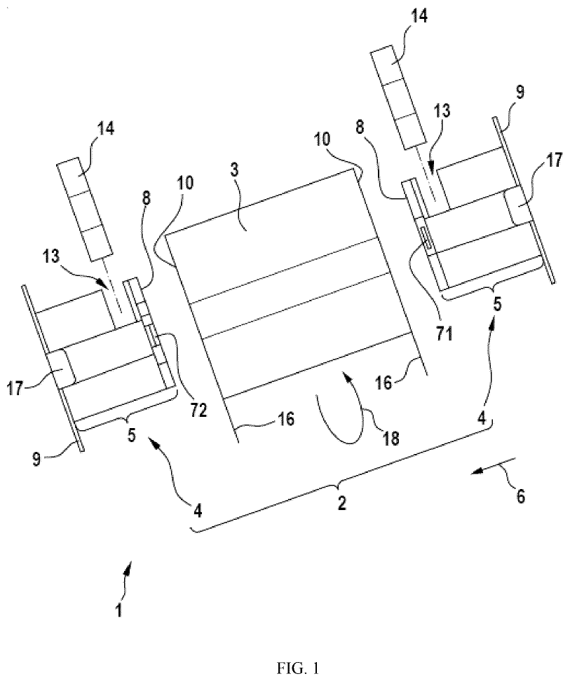

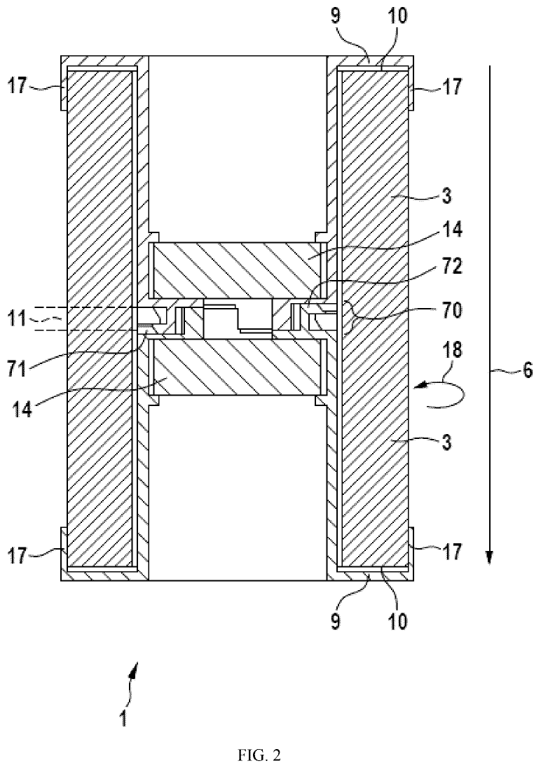

FIG. 1 shows a schematic explosion view of a magnetic component 1 according to a first embodiment of the present application. FIG. 2 shows a schematic assembled cross sectional view of the magnetic component 1 according to the first embodiment of the present application.

The magnetic component 1 of the present embodiment comprises a multi-part bobbin 2 and one winding unit 3. However, as will be elucidated in the following (see for example FIG. 3), the embodiment is not limited to a single multi-part bobbin 2 and a single winding unit 3.

Herein, the winding unit 3 is pre-wound and comprises one or more coil winding turns. For the sake of simplicity and overview, the individual coil windings are not shown in the figures. Further, the winding unit 3 is pre-wound edgewise (also commonly referred to as “side-winding”), wherein the windings are wound on their short sides, as opposed to their flat sides. In other words, the coil windings are substantially flat, elongated (much longer than wide) windings with rectangular cross sections, which are also known as “flat coils”. Further, a single winding unit 3 comprises the aforementioned coil winding turns and is characterized by comprising two ends 16 of said coil winding turns. In other words, a single coil comprising two coil (wire) ends 16 equates to a winding unit 3. An end 16 of the coil winding is, irrespective of its further connection, characterized in that it extends radially from the other wound portions of the coil winding, as shown in for example FIG. 1.

The multi-part bobbin 2 comprises a plurality of holding parts 4 configured to hold the winding unit 3. The plurality of holding parts 4 are separate, individual components or parts of the multi-part bobbin 2. In other words, the holding parts 4 are not integral or monolithic with one another.

The holding parts 4 each comprise a cylindrical portion 5 inserted into, along a longitudinal axis 6, which is parallel to a winding axis, of the winding unit 3, the winding unit 3 on either side so as to each be surrounded thereby. Further, said cylindrical portions 5 are, in the assembled state shown in FIG. 2, in contact with one another.

In some embodiments, each of the cylindrical portions 5 can be inserted into a plurality of winding units 3. In particular, these multiple winding units 3 can be paralleled, especially for a provision of more windings.

The two cylindrical portions 5, which contact one another within the winding unit 3, are attached to one another via a form-fit connection 70. In the present embodiment, the form-fit connection 70 consists of a snap-fit connection 71/72 which consists of a hook 72 (or cantilever) on one cylindrical portion 5 and an accommodating snap-in area 71 (see also FIG. 2). The snap-fit connection 71/72 is detachable, particularly destruction-free detachable. This allows for easy connection of the holding parts 4, as well as de-connection in case for example a mistake is made during manufacturing (for instance, holding parts 4 are mistakenly connected without first being inserted into winding unit 3).

The snap-fit connection 71/72, as shown in FIG. 2, is disposed within the winding unit 3. In other words, the winding unit 3 surrounds the snap-fit connection 71/72.

Advantageously, respective first end faces 8 of said two cylindrical portions 5 contact one another within the winding unit 3. The individual (for example hook/cantilever 72 or snap-in area 71) components of the form-fit connection are respectively disposed at the first end faces 8 of said two cylindrical portions 5. In a modification, the first end face 8 of a first cylindrical portion 5 out of said two cylindrical portions 5 is tapered so as to be insertable into a second cylindrical portion 5 out of said two cylindrical portions 5. In other words, in such a modification, the cylindrical portion 5 of one holding part 4 can be inserted into the cylindrical portion 5 of the other holding part 4.

Each of the holding parts 4 comprises a lid flange portion 9. Each lid flange portion 9 is in contact with an end face 10, along the longitudinal axis 6, of the winding unit 3. Although FIG. 2 shows a gap between the end faces 10 of the winding unit 3 and the lid flange portions 9, which may in some cases be especially depending on manufacturing tolerances and with regard to thermal expansion of the winding unit 3, the end faces 10 contact the lid flange portions 9. The lid flange portions 9 prevent or limit movement of the winding unit 3 along the longitudinal axis 6. Thereby, longevity and electric insulation of the magnetic component 1 is improved.

As shown in FIG. 2, the lid flange portions 9 comprise noses 17 which further hold the winding unit 3. In a modification, the noses 17 surround the winding unit 3 along its outer circumference 18 (perpendicular to longitudinal axis 6) completely, or nearly completely (at least 80%) with spaces left for the ends 16 to extend therethrough. Furthermore, the noses 17 may extend each along half of a length of the winding unit 3 along its longitudinal axis 6, thereby contacting or being in near-contact with one another along the longitudinal axis 6.

Herein, said two cylindrical portions 5 contact and attach to one another at a center portion 11, along the longitudinal axis 6, of the winding unit 3. In some embodiments, the center portion 11 is defined as the center or middle of the winding unit 3 within a margin of error. For example, the center portion 11 is defined by dividing (in thought) the winding unit 3, along its longitudinal axis 6, into eighths, wherein the center portion 11 is within the two middle eighths. In some embodiments, the center portion 11 is defined by the geometric middle within a range of ±15%, or ±10%, of the total length of the winding unit 3 along its longitudinal axis 6. In some embodiments, the total length of the winding unit 3 is determined only by the wound portions thereof, i.e. not including the aforementioned ends 16 of the winding, in the case these also extend along the longitudinal axis 6 (for example, being bent upward or downward in FIG. 2 along longitudinal axis 6).

In the present embodiment, the cylindrical portion 5 of the respective holding part 4 comprises a slot 13 configured to accommodate a ferrite pill 14. The ferrite pill 14 is a disc-shaped component comprising ferrite material, for instance as a pressed powder.

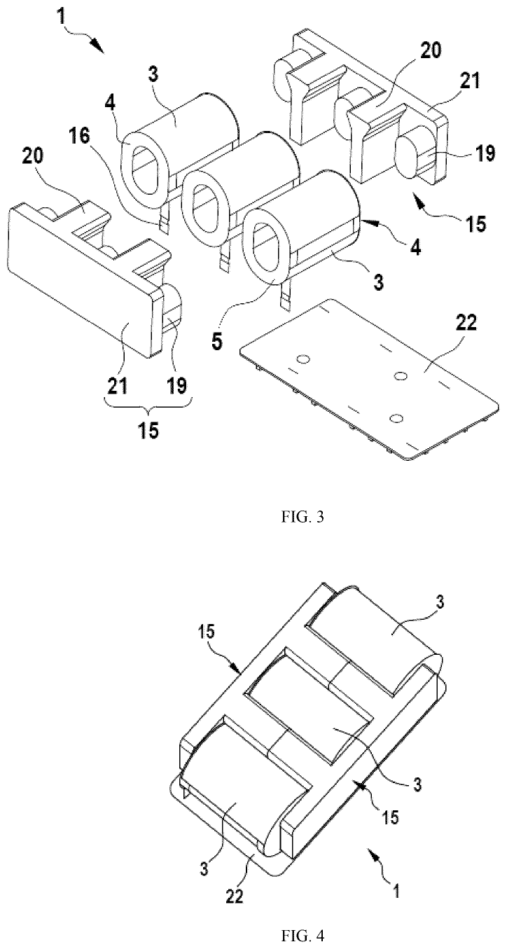

Although the foregoing describes a magnetic component 1 comprising one multi-part bobbin 2 and one winding unit 3, it is to be understood that the magnetic component 1 may comprise a plurality of multi-part bobbins 2 and winding units 3. This will be explained with reference to FIGS. 3 and 4. Therein, FIG. 3 shows a schematic explosion view of the magnetic component 1 according to the first embodiment of the present application, and FIG. 4 shows a schematic assembled view of the magnetic component 1 according to the first embodiment of the present application shown in FIG. 3. In other words, FIG. 4 shows the assembled state of FIG. 3.

In view of FIG. 3, the magnetic component 1 of the present example further comprises two magnetic cores 15. The cylindrical portions 5 are hollow and each house a portion of the magnetic core 15. In particular, in the present embodiment, each cylindrical portion 5 houses, on each of its sides, one winding leg 19, the magnetic core 15 further comprising return legs 20 for closing a magnetic circuit. The magnetic core 15 also comprises a base plate 21 connecting the winding legs 19 and the return legs 20 and closing the magnetic circuit.

The coil ends 16 are inserted into and connected to a circuit board 22.

This configuration is especially suited for a PFC choke assembly.

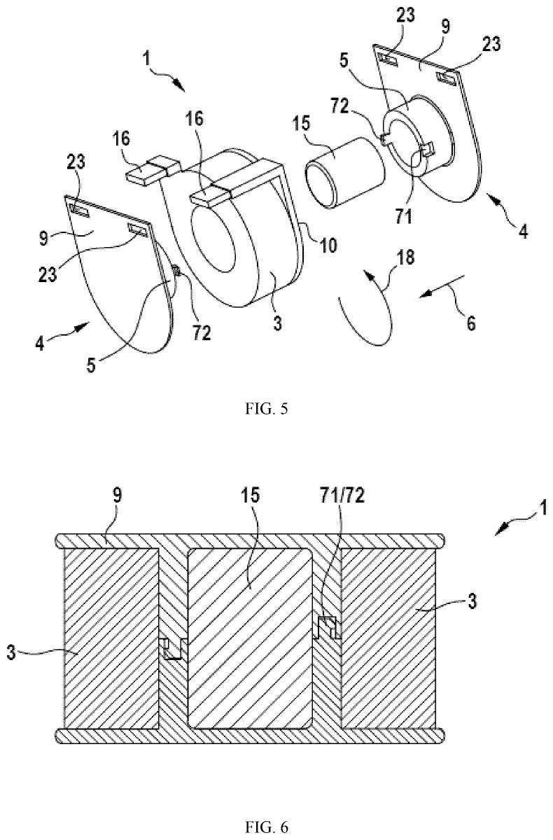

With reference to FIGS. 5 and 6, a second embodiment of the present application will be described. FIG. 5 shows a schematic explosion view of a magnetic component 1 according to a second embodiment of the present application, and FIG. 6 shows a schematic assembled cross sectional view of the magnetic component 1 according to the second embodiment of the present application.

As shown in FIG. 5, the lid flange portions 9 of each of the holding parts 4 have, in contrast to the circular shape thereof in FIG. 1, herein a combined rectangular and circular shape. Furthermore, the lid flange portions 9 comprise slots 23 for insertion of the coil ends 16.

Further, the magnetic core 15 of the present embodiment is a cylindrical magnetic piece inserted into, specifically between, the cylindrical portions 5 of the holding parts 4.

This configuration is especially suited for filter choke or EMI choke applications.

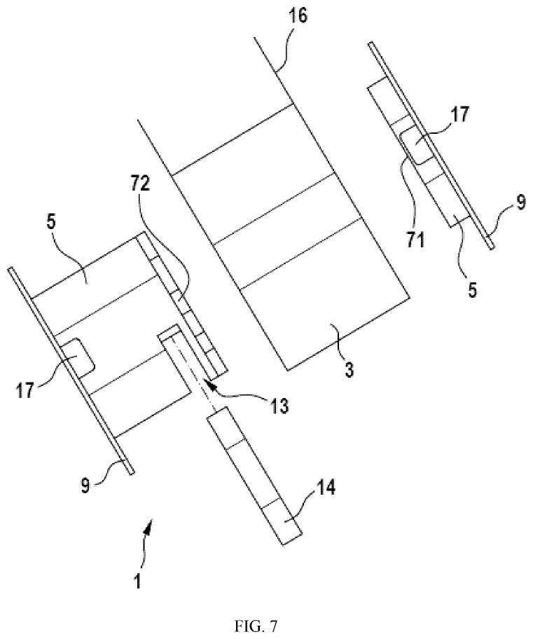

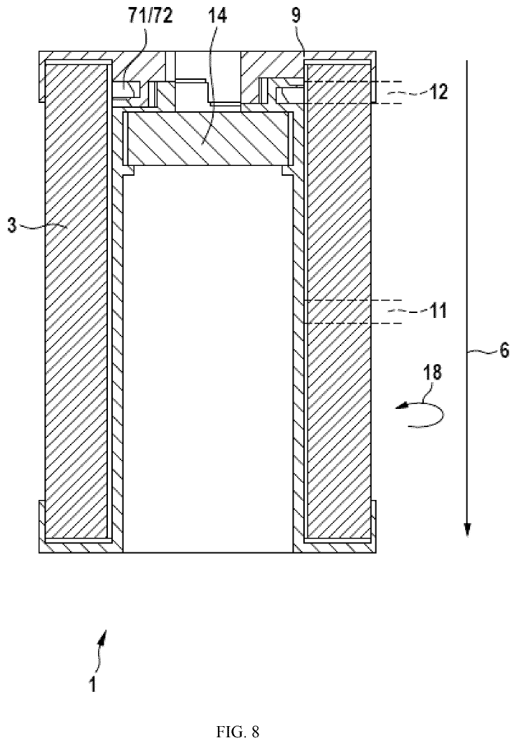

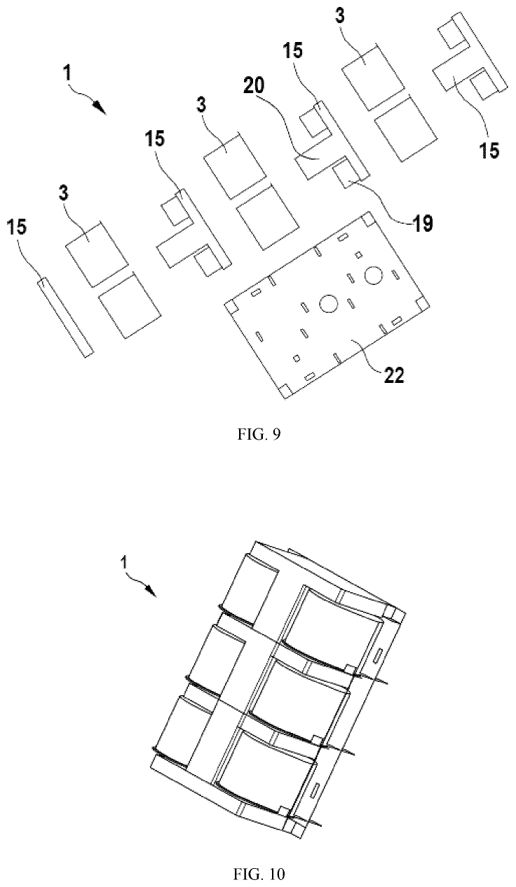

With reference to FIGS. 7, 8, 9, and 10, a third embodiment of the present application will be described. FIG. 7 shows a schematic explosion view of a magnetic component 1 according to a third embodiment of the present application, FIG. 8 shows a schematic assembled cross sectional view of the magnetic component 1 according to the third embodiment of the present application, FIG. 9 shows a schematic explosion view of the magnetic component 1 according to the third embodiment of the present application, and FIG. 10 shows a schematic assembled view of the magnetic component 1 according to the third embodiment of the present application.

As can be taken especially from FIGS. 7 and 8, in the present embodiment, with respect to different cylindrical portions 5 out of the two cylindrical portions 5, one (left side of FIG. 7, bottom of FIG. 8) is longer along the longitudinal axis 6 such that said cylindrical portions 5 contact and attach to one another at an end portion 12, along the longitudinal axis 6, of the winding unit 3. As especially a comparison between FIG. 8 and FIG. 2 shows, a point of contact herein is not at the center portion 11 due to the different lengths of cylindrical portions 5 of the respective holding parts 4.

In some embodiments, a point of contact at the end portion 12 of the two cylindrical portions is defined, with respect to the winding unit 3, as within a length range of 25% or less, or 15% or less, or 10% or less or 5% or less, from an end of the winding unit 3, particularly the wound portions thereof. In the shown example, their point of contact is roughly within 20% of a length from an end of the winding unit 3 along the longitudinal axis 6 thereof.

As shown in FIGS. 9 and 10, this allows for further different geometries of magnetic cores 15. In the present example, the magnetic cores 15 are three-legged, including two winding legs 19 and one return leg 20 each. Further, the magnetic component 1 comprises a bar-shaped magnetic core 15 (leg of FIG. 9) for closing the magnetic circuit.

This configuration is especially suited for six switch PFC choke applications.

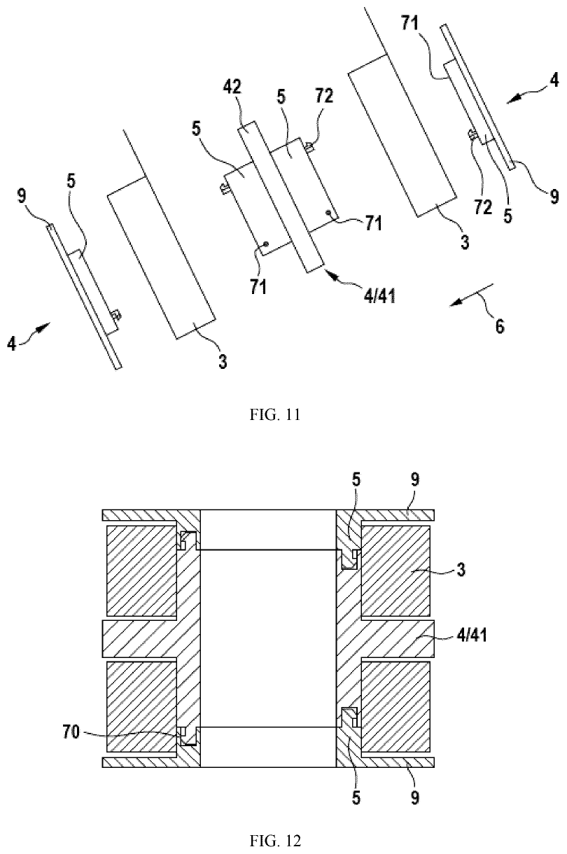

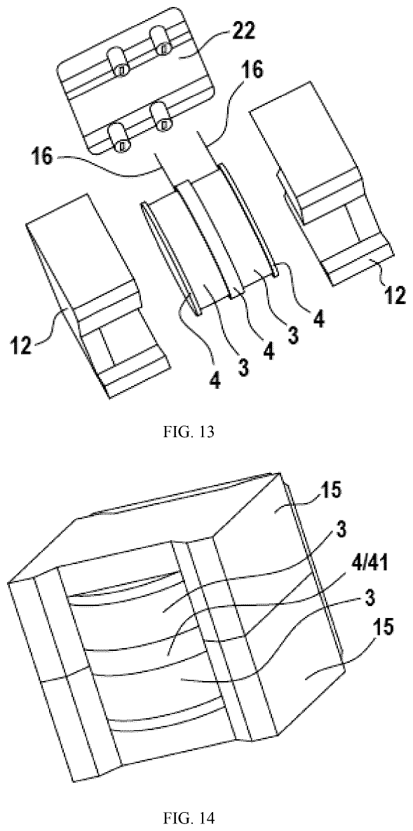

With reference to FIGS. 11, 12, 13, and 14, a fourth embodiment of the present application will be described. FIG. 11 shows a schematic explosion view of a magnetic component 1 according to a fourth embodiment of the present application, FIG. 12 shows a schematic assembled cross sectional view of the magnetic component 1 according to the fourth embodiment of the present application, FIG. 13 shows a schematic explosion view of the magnetic component 1 according to the fourth embodiment of the present application, and

FIG. 14 shows a schematic assembled view of the magnetic component 1 according to the fourth embodiment of the present application.

As can be taken especially from FIGS. 11 and 12, in the present embodiment, the magnetic component 1 comprises three holding parts 4. These three holding parts 4 of the multi-part bobbin 2 respectively comprise cylindrical portions 5.

Herein, one of the three holding parts 4 comprises two of said cylindrical portions 5, and is denoted as “two-sided holding part” 41.

Further, as shown, each of these cylindrical portions 5 of the two-sided holding part 41 is inserted respectively into one winding unit 3 and connects respectively with one cylindrical portion 5 of one of the other two holding parts 4 out of the three holding parts 4.

On the other hand, each of the cylindrical portions 5 of the two-sided holding part 41 may be inserted respectively into multiple winding units 3.

In other words, as can be taken from FIG. 11 and FIG. 12, one holding part 4 (left side) comprises a cylinder portion 5 inserted into a winding unit 3. Further, the two-sided holding part 41 also comprises a cylinder portion 5 inserted into the same winding unit 3. Further yet, another holding part 4 comprises a cylinder portion 5 inserted into a different (second) winding unit 3 (right side). The two-sided holding part 4 comprises a cylinder portion 5 also inserted into the different (second) winding unit 3.

Thereby, one multi-part bobbin 2 is capable of carrying at least two separate winding units 3. In some embodiments, any one or more of the other two holding parts 4 (those apart from the aforementioned two-sided holding part 41) can be replaced by another two-sided holding part 41, thus allowing for many winding units 3 being carried thereby.

The two of said cylindrical portions 5 of said two-sided holding part 41 extend in opposite directions along the longitudinal axis 6.

Further, the aforementioned two-sided holding part 41 comprises a flange portion 42 which connects the two cylindrical portions 5, especially integrally or monolithically. Furthermore, the flange portion 42 separates, along the longitudinal axis 6, the two winding units 3 into which the cylindrical portions 5 of the two-sided holding part 41 are inserted. Thereby, the flange portion 42 provides a fixed insulation distance between the two winding units 3 on either side thereof.

Furthermore, in the present embodiment, the two other holding parts 41 comprise the lid flange portions 9. In this combination, each winding unit 3 is sandwiched, along the longitudinal axis 6, between the flange portion 42 of the two-sided holding part 41 and the lid flange portion 9 of one of the two other holding parts 4. Thickness of flange portion 42 in longitudinal axis 6 is set to set DM inductance of CM choke.

Alternatively, in the case of multiple two-sided holding parts 41, at least one winding unit 3 may be sandwiched between the flange portions 42 of two adjacent two-sided holding parts 41.

In some embodiments, a thickness of the flange portion 42 along the longitudinal axis 6 is predetermined based on a predetermined DM inductance of for example a CM choke employing the magnetic component 1.

As shown in FIGS. 13 and 14, the magnetic cores 15 of the present embodiment are three-legged cores, pot cores of “RM” type, or an EP core. The present configuration is especially suited for DC CM choke applications.

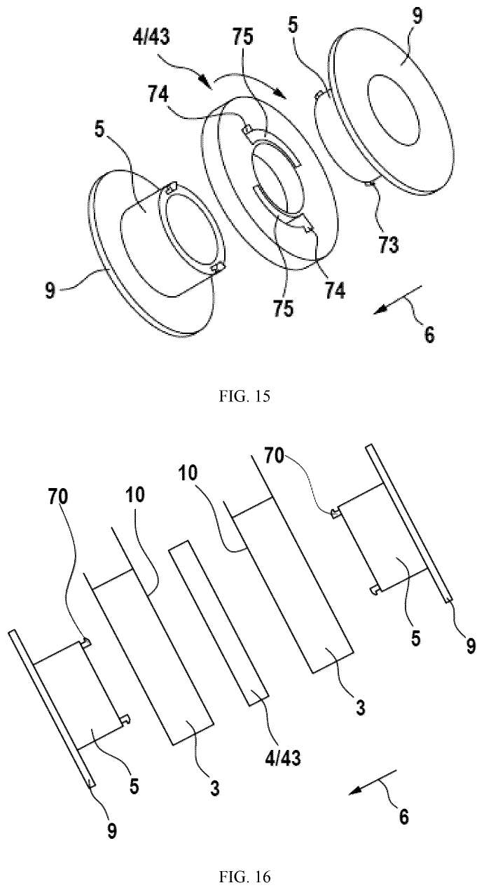

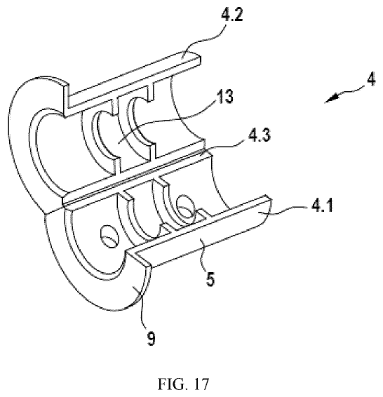

With respect to FIGS. 15 and 16, a fifth embodiment of the present application will be explained. FIG. 15 shows a schematic explosion view of aspects of a magnetic component 1 according to a fifth embodiment of the present application, and FIG. 16 shows another schematic explosion view of aspects of the magnetic component 1 according to the fifth embodiment of the present application.

In this embodiment, one of the holding parts 4 comprises a plate shape and is denoted as “a plate-shaped holding part” 43. The plate-shaped holding part 43 does not comprise a cylindrical portion 5 inserted into the winding unit 3. The cylindrical portion 5 of one other holding part 4 is inserted into the winding unit 3 and attached to the plate-shaped holding part 43.

Herein, in some embodiments, the thickness of plate-shaped holding part 43 along the longitudinal axis 6 is used to set a predetermined DM inductance of a CM choke employing the magnetic component 1.

The plate-shaped holding part 43 is further in contact with an end face 10 of the winding unit 3. Further, the winding unit 3 is sandwiched between the plate-shaped holding part 43 and the lid flange portion 9 of the other holding part 4 or a flange portion 42 of a two-sided holding part (see FIG. 11).

Further, as shown in FIG. 16, when the magnetic component 1 comprises two winding units 3, two of the holding parts 4 respectively comprise the cylindrical portion 5. The two cylindrical portions 5 are inserted respectively into the separate winding units 3 and attached on/to either face of the plate-shaped holding part 43 via the form-fit connection 70.

In the present embodiment, the form-fit connection 70 is a twist-and-lock connection 73, 74, 75. Herein, one component (for example cylindrical portion 5 of one of the holding parts 4 other than the plate-shaped holding part 43) comprises a hook or cantilever 73, whereas the respective other component (for example the plate-shaped holding part 43) comprises an annular groove or annular undercut 75, wherein the groove or undercut 75 comprises, along its annular extension, one or more recesses 74 into which the hook or cantilever 73 is insertable. By inserting the hook or cantilever 73 into the recess 74, and twisting the components (turning around longitudinal axis 6) 4/5 and/or 43, the hook or cantilever 73 is disposed behind a (recess-free) portion of the annular groove/undercut 75, such that its movement along the longitudinal axis 6 is blocked.

In view of FIG. 17, a sixth embodiment of the present application will be explained.

Herein, the holding part 4 comprises two halves 4.1, 4.2, for example half-cylinders, which are connected to one another, especially integrally or monolithically, via a hinge portion 4.3. Furthermore, the holding part 4 comprises the slot 13 for the ferrite pill 14.

Thereby, the aforementioned magnetic core 15 and/or ferrite pill(s) 14 can be easily inserted into the cylindrical portion 5 comprising the two halves 4.1, 4.2. In this case, the magnetic core 15 and/or ferrite pill 14 are inserted into one half

4.1, 4.2 of the holding part 4, the holding part 4 is closed via the hinge portion 4.3 and further inserted into the winding unit 3. In some embodiments, each of the halves 4.1, 4.2 includes a form-fit connection, especially a snap-fit connection, for attaching the two halves 4.1, 4.2 together once closed.

It should be noted that the embodiments of the application can be combined. For instance, the configuration of FIG. 8 can be applied to FIG. 4, i.e. the PFC choke assembly thereof. For instance, some winding units 3 may surround two holding parts 4 with the same lengths, or two holding parts 4 with the differing lengths. The ferrite pills 14 may, depending on applications, be inserted or left out. Furthermore, each of the holding parts 4 may also comprise a plurality of slots 13 for more ferrite pills 14. Any one or all of the holding parts 4 may comprise the two halves 4.1, 4.2.

In addition to the foregoing written explanations, it is explicitly referred to FIGS. 1 to 17, wherein the figures in detail show configuration examples of the application, and in particular show shapes of elements of the magnetic component 1.

What is claimed is:

1. A magnetic component comprising a multi-part bobbin and at least one winding unit, the multi-part bobbin further comprising:
a plurality of holding parts configured to hold the at least one winding unit, wherein the at least one winding unit is pre-wound and comprises one or more coil winding turns,
wherein at least one of the holding parts comprises a cylindrical portion inserted into, along a longitudinal axis of the winding unit, at least one winding unit so as to be surrounded thereby,
and
wherein said cylindrical portion is in contact and attached to a separate holding part via a form-fit connection.

2. The magnetic component according to claim 1, wherein the form-fit connection is a snap-fit connection or a twist-and-lock connection.

3. The magnetic component according to claim 1, wherein at least two separate holding parts of the holding parts respectively comprise the cylindrical portion, wherein the two cylindrical portions of the two separate holding parts are inserted into a single winding unit of the at least one winding unit, and wherein said two cylindrical portions within said single winding unit contact and are attached to one another via the form-fit connection.

4. The magnetic component according to claim 3, wherein the form-fit connection is disposed within said winding unit.

5. The magnetic component according to claim 3, wherein respective first end faces of said two cylindrical portions contact one another within said single winding unit.

6. The magnetic component according to claim 5, wherein the first end face of a first cylindrical portion out of said two cylindrical portions is tapered so as to be insertable into a second cylindrical portion out of said two cylindrical portions.

7. The magnetic component according to claim 5, wherein the at least two separate holding parts comprising said cylindrical portion each further comprise a lid flange portion, and wherein each lid flange portion is in contact with an end face, along the longitudinal axis, of the at least one winding unit.

8. The magnetic component according to claim 3, wherein said two cylindrical portions contact and attach to one another at a center portion, along the longitudinal axis, of the respective winding unit.

9. The magnetic component according to claim 3, wherein, out of said two cylindrical portions, one is longer along the longitudinal axis such that said two cylindrical portions contact and attach to one another at an end portion, along the longitudinal axis, of the respective winding unit.

10. The magnetic component according to claim 3, wherein three holding parts of the holding parts respectively comprise the cylindrical portion, wherein one of the three holding parts, as a two-sided holding part, comprises two of said cylindrical portions, wherein each of these cylindrical portions is inserted respectively into one winding unit and connects respectively with one cylindrical portion of one of the other two holding parts out of said three holding parts.

11. The magnetic component according to claim 10, wherein the two of said cylindrical portions of said two-sided holding part extend in opposite directions along the longitudinal axis.

12. The magnetic component according to claim 11, wherein said two-sided holding part comprises a flange portion connecting the two cylindrical portions and separating, along the longitudinal axis, the two winding units into which the cylindrical portions of the two-sided holding part are inserted.

13. The magnetic component according to claim 12, wherein respective first end faces of said two cylindrical portions contact one another within said single winding unit;
wherein at least two of the holding parts comprising said cylindrical portion each further comprise a lid flange portion, and wherein each lid flange portion is in contact with an end face, along the longitudinal axis, of the at least one winding unit; and
wherein each winding unit is sandwiched, along the longitudinal axis, between the flange portion of the two-sided holding part and the lid flange portion of one of the two other holding parts.

14. The magnetic component according to claim 1, wherein at least one of the holding parts comprises a plate shape, as a plate-shaped holding part, wherein the cylindrical portion of one other holding part is inserted into the winding unit and attached to the plate-shaped holding part, the plate-shaped holding part being in contact with an end face of the winding unit.

15. The magnetic component according to claim 1, wherein the cylindrical portion comprises at least one slot configured to respectively accommodate at least one ferrite pill or a magnetic core.

16. The magnetic component according to claim 15, wherein the at least one ferrite pill is respectively a disc-shaped component comprising ferrite material.

17. The magnetic component according to claim 1, wherein the cylindrical portion is hollow and houses a magnetic core.

18. The magnetic component according to claim 1, wherein the cylindrical portion has a circular or oval cross-section.

19. The magnetic component according to claim 1, wherein the cylindrical portion of at least one holding part is respectively inserted into at least two winding units.

20. The magnetic component according to claim 1, wherein at least one cylindrical portion of at least one holding part comprises two halves which are connected to one another via a hinge portion.
